(19) United States
(12) Patent Application Publication
(10) Pub. No.: US 2026/0276904 A1
(43) Pub. Date: Sep. 17, 2026

(54) Arrangement for Strain Relief of a Cable, Plug Connector Arrangement, and Method for Mounting a Cable in a Plug Connector

(71) Applicant: Rosenberger Hochfrequenztechnik GmbH & Co. KG, Fridolfing (DE)

(72) Inventors: Andreas Fischer, Eiselfing (DE); Till Bredbeck, Siegsdorf (DE)

(21) Appl. No.: 19/559,051

(22) Filed: Mar. 6, 2026

(30) Foreign Application Priority Data
Mar. 11, 2025 (EP) 25 162 817.8

(51) Int. Cl. G02B 6/38

(52) U.S. Cl. CPC G02B 6/3889; G02B 6/3826; G02B 6/3847; G02B 6/3861; G02B 6/3893

(57) ABSTRACT

An arrangement for strain relief of a cable, in particular an optical cable, comprising the cable and a tension-protection component fastened to the cable by means of an adhesive. A cable sheath of the cable within the tension-protection component is removed sectionally circumferentially or completely interrupted peripherally along a cable longitudinal axis (L) such that a cavity is formed between an inner side of the tension-protection component and a cable layer of the cable running below the cable sheath; into which cavity the adhesive is introduced.

The invention relates to an arrangement for strain relief of a cable, in particular an optical cable, comprising the cable and a tension-protection component fastened to the cable by means of an adhesive, according to the preamble of Claim 1.

The invention furthermore relates to a plug connector arrangement, comprising a plug connector, in particular an optical plug connector, and an arrangement for strain relief of a cable.

The invention also relates to a method for mounting a cable in a plug connector.

Various electrical and optical cable plug connectors are known from connection technology. Plug connectors serve, as is known, for transmitting data signals and/or electrical power to corresponding mating plug connectors. A plug connector or mating plug connector may be, inter alia, a plug, a socket or a coupling. The term “plug connector” or “mating plug connector” used within the context of the invention is representative of all variants.

In the case of a cable plug connector, the mechanical fastening of the cables within the plug connector housing plays a major role, so that tensile and/or transverse forces acting on the cable during operation do not cause damage to the plug connector arrangement.

A widely used method for cable strain relief is crimping, in which a sleeve or other housing component is attached to the cable by means of plastic deformation. In the case of electrical plug connectors, crimping is used regularly not only for mechanical fixing, but often also for electrically contacting an external conductor of the cable. By contrast, in the case of optical plug connectors, crimping technology is usually only used for mechanically fixing the optical cables.

However, disadvantages of the known crimping method include the fact that the crimping connection has to have sufficient strength to withstand mechanical loads caused by cable tension, but excessive crushing of the cable must not occur, in order not to damage the electrical or optical conductors within the cable.

In particular for cost reasons, for example to save on metallic support or crimp sleeves, it is also known to use an adhesive technique to fix the cables in the plug connector. For example, U.S. Pat. No. 6,331,080 B1 discloses an adhesive technique for fixing an optical cable in an optical plug connector. The adhesive is introduced into the plug connector housing in such a way that it is in direct contact with reinforcing fibres running in the optical cable.

However, it has been shown that the known adhesive techniques are usable only with great effort within the context of an automated assembly process and, in the event of particularly high mechanical loads, sometimes even do not provide sufficiently reliable mechanical fixing.

In view of the known prior art, it is the object of the present invention to provide an arrangement for strain relief of a cable, having a particularly high mechanical holding force, which can preferably be advantageously produced within the context of a partially or fully automated assembly process.

The present invention is also based on the object of providing a plug connector arrangement, having mechanically highly resilient cable strain relief, which can preferably be advantageously produced within the context of a partially or fully automated assembly process.

Finally, it is also the object of the invention to provide a method for mounting a cable in a plug connector, preferably an at least partially automated method, with which a mechanically highly resilient fixing of the cable to the plug connector is made possible.

The object is achieved, for the arrangement for strain relief, by means of the features specified in Claim 1. In respect of the plug connector arrangement, the object is achieved by the features of Claim 14 and, with regard to the method, by the features of Claim 15.

The dependent claims and the features described below relate to advantageous embodiments and variants of the invention.

The invention relates to an arrangement for strain relief of a cable, comprising the cable and a tension-protection component fastened to the cable by means of an adhesive.

Within the context of the invention, the cable may be an electrical or optical cable of any design. The invention may also be advantageous for so-called hybrid cables, i.e. cables having electrical and optical conductors.

An electrical cable within the context of the invention may comprise one or more electrical conductors, in particular one or more internal conductors and optionally an external conductor, which is spaced apart from the internal conductors via a dielectric and surrounds the internal conductors together (e.g. a cable shield braid and/or a shielding foil). For example, the electrical cable may be a coaxial cable, a twisted-pair cable, or a parallel-pair cable. The electrical cable may be designed, inter alia, as a data cable (e.g. high-frequency cable) and/or supply cable (e.g. high-voltage cable for an automobile).

An optical cable within the context of the invention may comprise at least one optical waveguide which serves for transmitting optical signals. The optical waveguide may in particular comprise glass or plastic, for example glass fibres or plastic fibres, and may be surrounded by one or more protective layers.

The construction of electrical and optical cables and their plug connectors is generally known, which is why further details and further examples are omitted in the present case. The invention is generally suitable for any type of cable and plug connector. In particular, the cable may also have any cross section, including round or flat geometries.

The fact that the tension-protection component is fastened to the cable should be understood as meaning in particular that the cable is located at least sectionally within the tension-protection component and, for example, does not touch only the end face of the tension-protection component or is fastened merely on the outside to a side surface of the tension-protection component. A portion of the cable is thus accommodated at least sectionally in the tension-protection component and said cable can thus end within the tension-protection component or be routed through the tension-protection component.

The tension-protection component may in principle be of any design (e.g. an integral or multi-part design) and be made of any material or any combination of materials. Preferably, the tension-protection component is an integral component, but this should not be understood as being limiting for the invention. Preferably, the tension-protection component is formed from a metal material and/or from a plastic material.

According to the invention, a cable sheath of the cable within the tension-protection component is removed sectionally circumferentially (for example, in the form of a window or partial ring) or completely interrupted peripherally along a cable longitudinal axis (for example, by a partial pulling-off of the cable sheath carried out within the context of processing of the cable, as also mentioned below) such that a cavity is formed between an inner side of the tension-protection component and a cable layer of the cable running below the cable sheath, into which cavity the adhesive is introduced.

Owing to the fact that said cavity is formed, inter alia, between the inner side of the tension-protection component (in particular the inner sheath or an inner circumferential surface of the tension-protection component) and said cable layer below the cable sheath, which cable layer is, however, exposed only sectionally within the tension-protection component, the mechanical holding force between the tension-protection component and the cable can be significantly increased. Along the cable longitudinal axis, steps or projections and offsets are formed in the radial or lateral direction, into which the adhesive is able to penetrate and behind which the adhesive therefore grips with a form fit in the cured state (in particular, if the cable sheath has been removed circumferentially only sectionally, the cured adhesive may “interlock” at multiple points in the cable sheath). In addition to said form fit, the integrally bonded connection itself can also be improved, since an increased adhesive surface is provided for the adhesive.

In the proposed way, cable strain relief can be provided which provides a high holding force without the use of crimping technology, with the advantage that damage to the electrical or optical conductors of the cable by excessive crushing can be ruled out. In addition, weight and costs can be saved since the use of crimp sleeves can be omitted.

Finally, it has also been shown that the adhesive technology can be used in a technically advantageous manner within the context of a partially automated or fully automated assembly process, which is why the invention can be readily suitable in particular for mass production.

In an advantageous development of the invention, it may be provided that said cable layer is a cable layer located directly below the cable sheath.

It has been shown that a cable layer located directly under the cable sheath can be particularly readily suitable for absorbing and dissipating high mechanical loads without the risk of damaging the electrical or optical conductors arranged further inwards. In principle, the cable layer which is in contact with the adhesive may, however, be a cable layer arranged at any distance below the cable sheath.

In principle, the cable layer, which is connected to the adhesive within the context of the invention, may be any cable layer of the cable, i.e. for example, a dielectric or an insulator of an electrical cable, a shielding foil or a rigid or elastic protective sheath made of a plastic or metal (for example, a primary or secondary protector of an optical cable).

According to a particularly preferred development of the invention, however, it may be provided in particular that said cable layer has strain relief elements, in particular reinforcing fibres, or consists of strain relief elements.

Preferably, the reinforcing fibres may be aramid fibres, kevlar fibres or metallic fibres (e.g. metallic fibres interwoven into a cable shield braid—in particular in an electrical cable).

In principle, however, any strain relief elements or reinforcing fibres are possible, for example even glass fibres, plastic fibres, organic fibres or other fibres.

In so far as reinforcing fibres are used, they may preferably—but not necessarily—be interwoven, intertwined or otherwise connected in order to further improve the mechanical properties. The reinforcing fibres are preferably wound around the cable along the cable longitudinal axis. The reinforcing fibres may run in an ordered manner, but possibly also in a completely disordered manner.

In so far as the cable sheath is completely interrupted peripherally along the cable longitudinal axis (that is, for example, by the partial pulling-off of the cable sheath already mentioned above), a further advantage according to the invention may be afforded within the context of the assembly of the plug connector in the case of a cable which has the reinforcing fibres described above. This is because since a subsection of the cable sheath is severed from the remaining cable sheath and partially pulled off in the direction of the front, free cable end, the free ends of the reinforcing fibres may still be covered by the subsection of the cable sheath. This prevents fraying of the reinforcing fibres, which simplifies a joining process for inserting the cable into the tension-protection component or into another plug connector component of the plug connector.

According to a development of the invention, it may be provided that the cable comprises one or more electrical or optical lines running below said cable layer (in particular at least one data line, such as one or more optical waveguides).

The cable layer which is in contact with the adhesive is therefore preferably not an optical line or an electrical internal conductor, which are preferably arranged further below said cable layer. However, in the case of an electrical cable, said cable layer may be an electrical external conductor of the electrical cable, which can generally be readily suitable for cable strain relief.

In a development of the invention, it may be provided that the tension-protect on component is fastened to an end portion of the cable.

Within the context of the invention, the tension-protection component is therefore preferably not fastened to a central portion of the cable, but is assigned to a free, axial end of the cable, in particular in order to connect the cable end or the end portion of the cable to a plug connector.

The end portion of the cable or its axial cable end may end inside the tension-protection component or emerge again from the tension-protection component. In the latter case, the cable or the corresponding cable end of the cable is completely routed through the tension-protection component, with it being possible for the openings for introducing and removing the cable in the tension-protection component to be aligned with each other or offset with respect to each other (depending on whether the strain relief arrangement is intended to be suitable, for example, for a rectilinear plug connector or for an angular plug connector).

It may be provided that the end portion of the cable is stripped at least sectionally, in particular adjacent to the front, free axial end, so that, in addition to the cable layer of the cable already mentioned above and connected to the adhesive, other cable layers of the cable (in particular electrical or optical conductors) are also available for contacting plug connector components of the plug connector.

It may preferably be provided that the cable or the end portion of the cable emerges with a rear, unprocessed cable portion from a cable-side end of the tension-protection component.

It can therefore be provided in particular that the cable or the end portion of the cable to which the tension-protection component is fastened has, starting from the front, free end (“plug-side end”), three axial portions:
a front cable portion stripped at least sectionally (which cable portion is preferably completely freed from the cable sheath);
a central cable portion in which the cable sheath of the cable is removed circumferentially sectionally or is interrupted completely peripherally along the cable longitudinal axis in order to form the cavity mentioned according to the invention for the adhesive (which central cable portion therefore still partially has the cable sheath); and
a rear unprocessed cable portion (which still has the unprocessed cable sheath) that runs through the cable-side opening of the tension-protection component.

In a development of the invention, it may be provided that, in order to form the cavity within the tension-protection component, the cable sheath is removed circumferentially at least by an angular range of 15°, preferably at least 30°, more preferably at least 45°, even more preferably at least 60°, in particular at least 90° or more, for example 120°, 140°, 160°, 180° or even more.

The circumferentially removed portions of the cable sheath are preferably partially annular or window-shaped openings in the cable sheath. Preferably, however, they are not individual bores, channels or punctures in the cable sheath.

In an advantageous development of the invention, it may be provided that, in order to form the cavity within the tension-protection component, the cable sheath is completely interrupted peripherally at least over an axial length of 0.5 mm, preferably over an axial length of at least 1.0 mm, more preferably of at least 1.2 mm, for example over an axial length of approximately 1.4 mm or more.

Therefore, preferably, an annular groove or a completely annularly encircling axial distance between the severed subsection and the remaining cable sheath is formed. Preferably, the resultantly formed cavity is larger in the axial direction than a slot formed only by the annular cutting of the cable sheath by the cutting tool. The axial distance between the severed subsection of the cable sheath and the remaining cable sheath is therefore preferably greater than the width of the cutting tool for annularly severing the cable sheath.

It can be provided that the adhesive
a) directly contacts an area of the cavity or recess(es) in the cable/cable sheath or an outer circumferential surface of the cable layer; and/or
b) directly contacts an end face of the cable sheath or a side surface of the recess formed in the cable sheath; and/or
c) directly contacts an inner circumferential surface of the tension-protection component; and/or
d) directly contacts a side surface of the access opening, also mentioned below.

In a development of the invention, it may be provided that the adhesive at least substantially completely fills the cavity.

Preferably, the adhesive at least substantially completely contacts said cable layer on the outer circumferential side. Preferably, the adhesive also at least substantially completely contacts the tension-protection component in the region of the cavity on the inner circumferential side. The adhesive does not necessarily have to extend into a possible access opening for introducing the adhesive (also mentioned below).

In an advantageous development of the invention, it may be provided that the adhesive is a light-curing adhesive, in particular a UV-curing adhesive. Alternatively or in addition, the adhesive may also be a thermally curing adhesive.

Within the context of a partially automated or fully automated assembly process, light-curing or thermally curing adhesives in particular can be readily suitable, since the curing time and the curing duration can be easily controlled in this case. In principle, however, almost any adhesives are possible within the context of the invention, such as, for example, air-curing or drying-curing adhesives, adhesives curing by cooling or adhesives curing by adding another substance.

Depending on the size or volume of the cavity, the geometrical design of the cavity and the expected tensile forces, a person skilled in the art may in principle select a suitable adhesive, for example with regard to viscosity, in such a way that an even distribution in the adhesive chamber or in the cavity is possible.

In an advantageous development of the invention, it may be provided that the adhesive is a self-adhesive, primer-free adhesive.

Within the context of the invention, a self-adhesive adhesive should be understood as meaning an adhesive which does not require a so-called “primer” (also called “adhesion promoter”) for the required adhesion to the surface of the cable layer and of the tension-protection component. This means that an otherwise possibly required pre-treatment of the cable layer or of the tension-protection component can be omitted. In special cases (less preferred), however, the adhesive used within the context of the invention may also be an adhesive that requires a primer.

In an advantageous development of the invention, it may be provided that the tension-protection component has at least one access opening which leads into the cavity and is intended for introducing the adhesive.

The access opening can serve merely for introducing the adhesive and, after the adhesive is introduced, is not filled itself by the adhesive. Preferably, however, the adhesive after being Introduced extends at least partially even into the access opening—the adhesive may possibly even completely fill the access opening.

Optionally, the access opening may be closable and have a closure element, but this is not generally required since the access can be sufficiently sealed by the adhesive itself.

In principle, any number of access openings may be provided for introducing the adhesive, with just one access opening already being generally sufficient.

However, an access opening may also be completely dispensed with, for example, if the adhesive has already been introduced into the tension-protection component through an entry opening provided for the cable and/or has been applied to the regions of the cable removed from the cable sheath before the cable is inserted into the tension-protection component (less preferred). Even if the tension-protection component is a multi-part component, which comprises, for example, a first housing shell and a second housing shell which can be fitted together with the first housing shell, an access opening for introducing the adhesive may optionally be omitted, since the adhesive can then be advantageously applied when the two housing shells are still open.

In a development of the invention, it may be provided that the tension-protection component is jointly fastened to a plurality of cables, which are arranged in a joint cable receptacle or in respective cable receptacles.

For example, the arrangement for strain relief may have precisely one, two, three, four, five, six or even more cables, which are in each case or jointly fixed mechanically by the adhesive in the manner described.

It may be provided, for example, that the tension-protection component has one or more cable-side openings for supplying the plurality of cables, each opening ending in a chamber or feedthrough for the cable or cables. If each of the chambers or feedthroughs is assigned to only one cable, a respective cavity may be formed in each chamber between the inner side of the tension-protection component and the respective, partially exposed cable layer of the cable. Preferably, in the case of a plurality of chambers or feedthroughs, the chambers or feedthroughs are at least connected to one another (e.g. by channels or openings in intermediate walls) in such a way that it is sufficient to introduce the adhesive through a joint access opening, in order to reduce the outlay on assembly.

According to a development of the invention, it may be provided that the tension-protection component is a plug connector housing of a plug connector or a plug connector component which is fastenable in a plug connector housing of a plug connector.

The tension-protection component can therefore be, for example, part of a one-part or multi-part plug connector housing. However, the tension-protection component may in principle also only be a plug connector component of the plug connector, which is fastenable separately in the plug connector housing. For this purpose, the tension-protection component may in principle be fastenable in the plug connector housing in any way, for example with an integral bond, with a force fit and/or with a form fit. The tension-protection component can be fixed with a form fit in the plug connector housing, in particular by mutual latching. For this purpose, it may be provided, for example, that one or more elastic latching arms or latching hooks of the plug connector housing engage in a corresponding recess or offset of the tension-protection component—or vice versa.

According to a development of the invention, it may be provided that the cable sheath of the cable and/or the inner side or inner circumferential surface of the tension-protection component has at least one recess encircling sectionally circumferentially or completely circumferentially in order to form at least one further cavity between the cable sheath of the cable and the inner side of the tension-protection component.

In this way, the holding force between the cable and the tension-protection component can be increased further.

The further cavity can preferably be spaced apart from the cavity (in particular in the direction of the cable longitudinal axis) or can extend the cavity (i.e. merge directly into the cavity).

The invention also relates to a plug connector arrangement, comprising a plug connector and one or more arrangements for strain relief of a cable according to the embodiments above and below.

Advantageously, a plug connector arrangement having an arrangement for strain relief of a cable can be provided, which can be suitable for particularly high mechanical tensile and transverse forces, without the risk of mechanical damage to electrical and/or optical lines of the cable. The plug connector arrangement can be designed to absorb cable tensile forces of at least 50 N, preferably at least 100 N or more.

Within the context of the invention, a completely metal-free optical plug connector arrangement can optionally be provided, since conventional crimping technology, and thus possible metallic crimp sleeves, can be dispensed with. A completely metal-free design may be advantageous in terms of cost, weight and sometimes because of the application (e.g. for medical applications for use in an MRI).

The plug connector may preferably be an optical plug connector. However, the plug connector may also be an electrical plug connector or a hybrid plug connector that has optical and electrical components.

Preferably, the plug connector has a plug connector housing, which can be formed in one or more parts, for example from a plastic and/or from a metal. As already mentioned above, the tension-protection component may be a plug connector component which is separate from the plug connector housing or be formed integrally or monolithically with the plug connector housing.

As also already mentioned above, the invention is suitable in principle for use with plug connectors of any design. For example, rectilinear plug connectors or angular plug connectors may be suitable within the context of the invention. The plug connector may have any plug connector components and functional regions, such as, for example, a plug-side plug connector interface (“interface”) for connection to a corresponding mating plug connector, which has a connection between electrical and/or optical contact elements of the plug connector and corresponding electrical and/or optical mating contact elements of the mating plug connector and/or mechanical latching and connecting means (for example, latching hooks and/or latching rockers) for mechanically latching or connecting to a mating plug connector housing of the mating plug connector.

The plug connector housing may optionally have one or more sealing elements in the region of an entry opening for the at least one cable or the arrangement for strain relief, in order to seal the interior of the plug connector against liquids, dust or other contaminants. In particular, if the tension-protection component is formed integrally or monolithically with the plug connector housing or corresponds to the plug connector housing, the cable seal in the region of said cavity may also already be formed by said adhesive.

The plug connector may have one or more contact elements for connection to corresponding mating contact elements of the mating plug connector. For example, a contact element may be an electrical contact element (for example, a pin contact, a flat contact, a contact spring element, a socket, or an electrical contact element of other design). In the case of an optical plug connector, the contact element may preferably be an optical ferrule. The electrical or optical contact element may be mounted optionally in a spring-loaded manner in the plug-in direction.

The invention also relates to a method for mounting a cable in a plug connector, comprising at least the following method steps:
providing a cable, in particular an optical cable;
providing a tension-protection component of the plug connector;
removing a cable sheath of the cable circumferentially sectionally, or circumferentially completely severing and carrying out a partial pulling-off of the cable sheath;
introducing a cable portion of the cable (the cable sheath of which has already been processed as described above or will subsequently also be processed as described above) into the tension-protection component;
introducing an adhesive into a cavity between an inner side of the tension-protection component and a cable layer of the cable running below the cable sheath (which has been partially exposed in the above-mentioned cable portion) in order to fasten the tension-protection component to the cable.

At this juncture, it should be stressed that the method steps mentioned above and below do not necessarily have to be carried out in the order in which they are first described or mentioned in the description or in the claims. For example, individual method steps or groups of method steps can therefore be interchangeable unless this is technically ruled out. Method steps may also be combined with one another, divided into separate intermediate steps or supplemented with intermediate steps. The method is also not necessarily conclusively described with the described method steps and may be supplemented with further method steps, even ones not mentioned.

In an advantageous manner, cable strain relief can be provided in adhesive technology with a particularly strong holding force for a cable plug connector.

In particular, if said cable layer is a cable layer having reinforcing fibres, and if a partial pulling-off of the cable sheath is used to expose the cable layer in the central cable portion of the cable, the proposed mounting process may be further improved compared to the prior art, since, in this case, “threading” or introducing the pre-processed cable into the tension-protection component can be simplified, since it is ensured that the reinforcing fibres in the front, already partially stripped cable portion of the cable are still held below the subsection of the cable sheath and do not protrude in a disordered way from the outer circumference of the cable layer or are frayed.

Within the context of the method described above, it may optionally be provided that a front cable portion of the cable is stripped at least sectionally, for example, to make an electrical Internal conductor and/or an optical waveguide accessible for connection to a corresponding plug connector component or a contact element of the plug connector. Furthermore, in a further method step, the mounting of an electrical or optical contact element (e.g. an optical ferrule) on the exposed electrical or optical conductor may be provided.

In addition, the invention also relates to an apparatus for mounting a cable in a plug connector, preferably designed for carrying out the above-mentioned method, comprising
a device for processing a cable sheath, for removing a cable sheath from the cable sectionally circumferentially or for carrying out a partial pulling-off of the cable sheath, in particular within the context of a stripping process;
a feed and fitting device for introducing a portion of the cable (in particular an end portion) into a tension-protection component of the plug connector, in particular along the longitudinal axis of the cable; and
a device for feeding an adhesive into the tension-protection component.

The apparatus and/or the devices mentioned preferably has or have a control device which is designed for carrying out the individual method steps or for controlling and monitoring the above-mentioned working steps. The control device may be designed as a microprocessor. Instead of a microprocessor, any other device for implementing the control device may also be provided, for example one or more arrangements of discrete electrical components on a printed circuit board, a programmable logic controller (PLC), an application-specific integrated circuit (ASIC) or another programmable circuit, for example also a field programmable gate array (FPGA), a programmable logic arrangement (PLA) and/or a commercially available computer.

Features which have been described in connection with one of the subjects of the invention, which are specifically the arrangement according to the invention for strain relief of the cable, the plug connector arrangement according to the invention, the method according to the invention or the apparatus according to the invention, are also advantageously implementable for the other subjects of the invention. Likewise, advantages specified in connection with one of the subjects of the invention can also be understood in relation to the other subjects of the invention.

In addition, it should be noted that terms such as “comprising”, “having” or “with” do not exclude other features or steps. Furthermore, terms such as “a/an” or “the” indicating steps or features in the singular do not exclude a plurality of features or steps—and vice versa.

In a puristic embodiment of the invention, it can however also be provided that the features introduced in the invention by the terms “comprising”, “having” or “with” constitute an exhaustive enumeration. Accordingly, in the context of the invention, one or more enumerations of features can be considered to be self-contained, for example considered in each case for each claim. By way of example, the invention can consist exclusively of the features specified in Claim 1.

It should be mentioned that labels such as “first” or “second” etc. are used predominantly for the sake of distinguishability between respective apparatus or method features, and are not necessarily intended to indicate that features are mutually dependent or related to one another.

Furthermore, it should be emphasized that the values and parameters described in the present case also encompass deviations or fluctuations of ±10% or less, preferably ±5% or less, more preferably ±1% or less, and very particularly preferably ±0.1% or less, of the respectively stated value or parameter, provided that these deviations are not excluded in practice when implementing the invention. The specification of ranges by way of start and end values also encompasses all values and fractions encompassed by the respectively stated range, in particular the start and end values and a respective mean value.

Exemplary embodiments of the invention will be described in more detail below with reference to the drawings.

The figures each show preferred exemplary embodiments in which individual features of the present invention are illustrated in combination with one another. Features of one exemplary embodiment are also implementable separately from the other features of the same exemplary embodiment, and can accordingly be readily combined by a person skilled in the art to form further useful combinations and sub-combinations with features of other exemplary embodiments.

In the figures, functionally identical elements are provided with the same reference signs.

In the figures, in each case schematically:

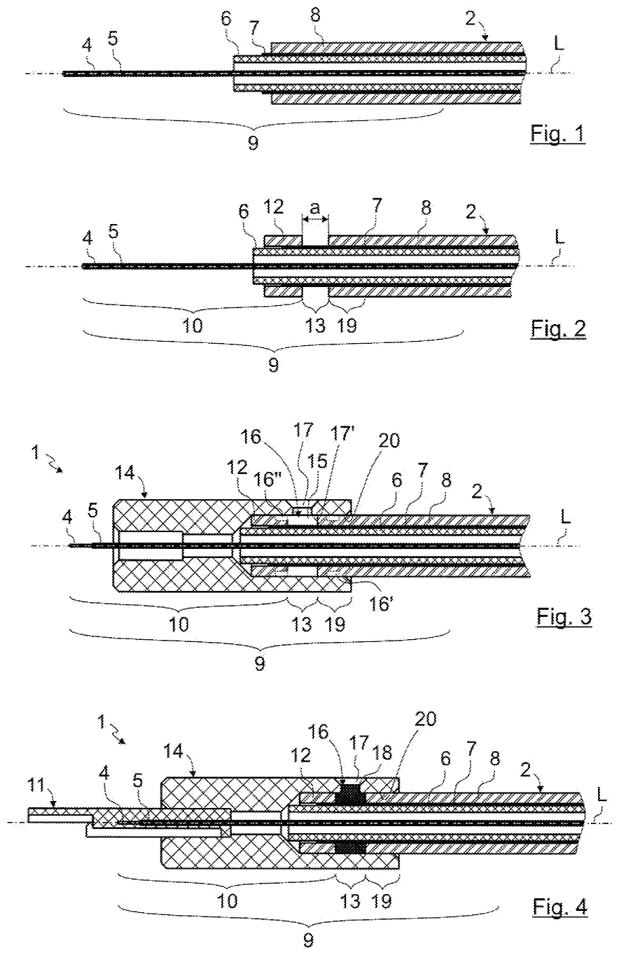

FIG. 1 shows an end portion of an optical cable partially stripped in a front cable portion, for subsequent use with an arrangement according to the invention, in a lateral sectional illustration;

FIG. 2 shows the end portion of the optical cable according to FIG. 1, after a partial pulling-off of the cable sheath in a central cable portion has been carried out;

FIG. 3 shows an arrangement according to the invention consisting of the optical cable according to FIG. 2 and a tension-protection component receiving the cable, with cavities between an inner side of the tension-protection component and a cable layer exposed sectionally below the cable sheath;

FIG. 4 shows the arrangement according to FIG. 3, after an adhesive has been introduced into the cavity;

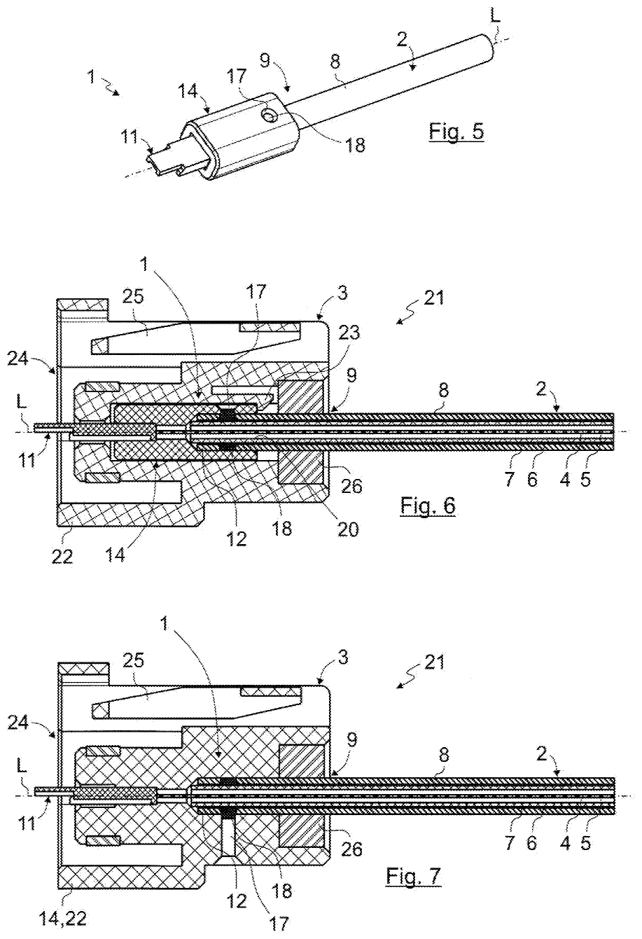

FIG. 5 shows the arrangement according to FIG. 4 in a perspective illustration;

FIG. 6 shows a plug connector arrangement according to the invention consisting of an optical plug connector and an arrangement fastened in the plug connector housing according to FIG. 4; and

FIG. 7 shows a plug connector arrangement according to the invention according to a further exemplary embodiment, consisting of an optical plug connector, the plug connector housing of which also forms the tension-protection component.

FIGS. 1 to 5 show an arrangement 1 according to the invention for strain relief of a cable 2 in various mounting states. The fully mounted state of the arrangement 1 is shown in FIG. 4 in a sectional view and in FIG. 5 in a perspective view.

The cables 2 illustrated in the figures are each, by way of example, optical cables 2, and the plug connectors 3 which are illustrated and also described later are therefore optical plug connectors 3. In principle, however, the invention may also be advantageously suitable for use with electrical cables or electrical plug connectors. Hybrid cables or hybrid plug connectors may also be provided. The exemplary embodiments described below are therefore intended to describe the invention only by way of example for optical connector technology.

The optical cable 2 illustrated, inter alia, in FIG. 1 has an optical waveguide 4 (for example, a glass fibre), which is encased by a so-called primary protector 5 or a primary coating. The optical cable 2 illustrated in the figures has, by way of example, only a single optical waveguide 4; in principle, a cable 2 may, however, have any number of optical waveguides 4 or data lines and/or electrical supply lines within the context of the invention. The optical waveguide 4 extends within a sleeve-shaped secondary protector 6 (“tube”), which is surrounded by a cable layer 7 comprising reinforcing fibres. Examples of the reinforcing fibres, not illustrated specifically, may include aramid fibres or kevlar fibres. An outer circumference or cable sheath 8 of the cable 2 runs immediately above or outside the cable layer 7 comprising the reinforcing fibres. The cable structure which is illustrated and described should be understood as being merely by way of example.

FIG. 1 shows the optical cable 2 in an already partially processed state. The end portion 9 shown of the cable 2 is provided for mounting in a corresponding plug connector 3, which is also described below with reference to FIG. 6. The end portion 9 has the front cable portion 10, which is illustrated in FIG. 1 and is stripped sectionally to provide the connection of the optical waveguide 4 to an optical ferrule 11 (see, inter alia, FIGS. 4 and 5). For this purpose, the cable sheath 8 of the cable 2 is severed at a predefined axial position or stripped in such a way that the layers of the cable 2 running under the cable sheath 8 are accessible. The cable layer 7 running directly below the cable sheath 8 and having the reinforcing fibres already mentioned is also shortened at an axial position arranged further forwards so that it protrudes out of the axial end of the cable sheath 8. Furthermore, the secondary protector 6 or the “tube” has been removed in a portion located even further forwards, so that the optical waveguide 4 together with primary protector 5 or primary coating is exposed to a sufficient extent for further processing and connection to the ferrule 11.

In a further mounting step or in a further step for the pre-processing of the cable 2, a so-called partial pulling-off of the cable sheath 8 can be carried out, as Illustrated in FIG. 2. That is to say, a front subsection 12 of the cable sheath 8 has been severed annularly from the remaining cable sheath 8 at a position spaced apart from the axial end of the cable sheath 8 and partially pulled off in the direction of the front, free end of the cable 2. In the exemplary embodiment, the subsection 12 has been pulled off in such a way that the exposed reinforcing fibres of the cable layer 7 located directly below the cable sheath 8 end below the subsection 12, so that fraying of the reinforcing fibres is prevented, which can greatly simplify the further assembly. The cable sheath 8 is thus completely Interrupted peripherally in a central cable portion 13 of the illustrated end portion 9 of the cable 2 over a defined axial length a (cf. FIG. 2) by the partial pulling-off which has been carried out.

At this juncture, it should be mentioned that, alternatively or in addition to the carrying out of a partial pulling-off, provision may also be made to remove the cable sheath 8 of the cable 2 in the central cable portion 13 circumferentially only sectionally. This means that, alternatively or additionally, for example, partially annular or window-shaped recesses can be introduced into the cable sheath 8 (not illustrated). For this purpose, the cable sheath 8 can be circumferentially removed, for example, by an angular range of at least 30°.

In FIG. 3, the pre-processed optical cable 2 illustrated in FIG. 2 is inserted in a tension-protection component 14 of the arrangement 1. Before or even after the insertion, the primary protector 5 or the primary coating of the optical waveguide 4 has also been removed (“cleaved”), so that the optical waveguide 4 is sufficiently exposed for further connection to the optical ferrule 11 Illustrated in FIG. 4. FIG. 4 shows the optical waveguide 4 when already mounted in the ferrule. In addition, FIG. 5 also shows the arrangement 1 according to the invention in a perspective illustration.

As can be easily seen in FIG. 3, a cavity 16 is formed in the central cable portion 13 of the optical cable 2 and an inner side 15 of the tension-protection component 14 because of the partial pulling-off of the cable sheath or because of the cable sheath 8 being interrupted peripherally along the cable longitudinal axis L.

The tension-protection component 14 has an access opening 17 leading into the cavity 16. In a subsequent method step, an adhesive 18 can be introduced into the cavity 16 through said access opening 17 in order to fasten the tension-protection component 14 to the cable 2 in an integrally bonded manner (cf. FIG. 4). It may be provided that an extent of the access opening 17 in the direction of the cable longitudinal axis, in particular a diameter of the access opening 17, is smaller than an extent of the cavity 16 in the direction of the cable longitudinal axis, so that an offset or an edge 17 (cf. FIG. 3) is formed at the transition between the access opening 17 and the cavity 16. In this way, an additional form fit can be created after the adhesive 18 has been introduced and has cured. However, an edge 17′ between the cavity 16 and the access opening 17 is not necessarily required, which is why said extents in the direction of the cable longitudinal axis may also be identical. The access opening 17 may optionally also have a larger extent in the direction of the cable longitudinal axis than the cavity 16 (less preferred).

The adhesive 18 preferably at least substantially completely fills the cavity 16. Owing to the cavity 16 created by the partial pulling-off of the cable sheath 8, an increased adhesive surface is provided for the adhesive connection, which improves the holding force of the tension-protection component 14 on the optical cable 2. Furthermore, by gripping behind the formed edges of the cable sheath 8, further improved fixing by means of an additional form fit can be provided, in particular if the cable sheath 8 has been removed sectionally circumferentially.

A suitable adhesive 18 may in particular include adhesives 18 which are self-adhesive and for which therefore preferably a primer is not required. The adhesive 18 may preferably be a light-curing, in particular UV-curing, or a thermally curing adhesive 18.

It may be optionally provided that, in addition to the cavity 16 already described between the cable layer 7 and the inner side 15 of the tension-protection component 14, one or more further cavities 16′, 16″ are created between the cable sheath 8 of the cable 2 and the inner side 15 of the tension-protection component 14. For this purpose, the cable sheath 8 can be partially removed in the lateral or radial direction or can have a recess (sectionally circumferentially or completely peripherally), for example by means of previous abrasive processing. A corresponding peripheral additional cavity 16′, which is spaced apart from the cavity 16 in the direction of the cable longitudinal axis, is indicated by dashed lines in FIG. 3 (by way of example on the right or cable side next to the cavity 16). By way of example, FIG. 3 furthermore also shows a further cavity 16″ by dashed lines, said cavity merging directly into the cavity 16 and therefore extending the cavity 16 (by way of example on the left or plug connector side next to the cavity 16). Alternatively or additionally, an additional cavity 16′, 16″ may also be formed by a recess in the tension-protection component 14 (not illustrated). The additional cavity or cavities 16′, 16″ can be filled with the adhesive 18 through a separate access opening or by a connection (e.g. a channel or other opening) to the access opening 17 already described. If the cavity 16″ extends the cavity 16 or merges directly into the cavity 16, a separate access opening or a separate connection may possibly be omitted. The additional cavities 16, 16″ enable the holding force between cable 2 and the tension-protection component 14 to be increased further.

As can be seen, for example, from FIGS. 3 and 4, a rear cable portion 19 of the end portion 9 of the cable fastened to the tension-protection component 14 is unprocessed or still completely has the cable sheath 8 and is routed through a cable-side opening 20 in the tension-protection component 14, preferably in an at least substantially precisely fitting manner.

At this juncture, it should be mentioned that the tension-protection component 14 may in principle also be fastened jointly to a plurality of cables 2. In the exemplary embodiments, only a single cable 2 is illustrated in each case purely by way of example. However, this should not be understood as being limiting.

FIG. 6 shows a plug connector arrangement 21 according to the invention consisting of an optical plug connector 3 and the arrangement 1 fastened in a plug connector housing 22 of the plug connector 3 in FIGS. 4 and 5. The above-described arrangement 1 for strain relief is latched for this purpose, by way of example, in the plug connector housing 22. For this purpose, the plug connector housing 22 has an elastic latching arm 23, which grips behind the rear edge of the tension-protection component 14. In principle, however, any fastening technique is possible (i.e., optionally even a force-fitting and/or integrally bonded fastening).

The plug connector housing 22 has a mechanical and optical interface 24 for connection to a corresponding mating plug connector (not illustrated). By way of example, a latching rocker 25 is illustrated for the latching of the plug connection.

In the introducing region for the cable 2, the plug connector 3 has, by way of example, a generally optional sealing element 26.

As already mentioned, the plug connector 3 illustrated should be understood as being merely by way of example. The invention is generally suitable for use with any plug connector 3. In addition, it may also be provided within the context of a plug connector arrangement 21 according to the invention that a plurality of tension-protection components 14 for in each case one or more cables 2 are received and fastened together in the plug connector housing 22.

FIG. 7 shows a second exemplary embodiment of a plug connector arrangement 21 according to the invention. In contrast to the exemplary embodiment of FIG. 6, the plug connector housing 22 in FIG. 7 forms the tension-protection component 14 or the plug connector housing 22 is simultaneously the tension-protection component 14. Separate latching, as in FIG. 6, is therefore not required. Accordingly, the access opening 17 for introducing the adhesive 18 is completely led out through the plug connector housing 22 in order to supply the adhesive 18 in an advantageous manner from the outside. In contrast thereto, in the exemplary embodiment in FIG. 6, it is usually not necessary that the access opening 17 remains accessible from outside the plug connector housing 22 in the mounted state of the tension-protection component 14.

At this juncture, it should be mentioned that, as an alternative to feeding the adhesive 18 through an access opening 17, the plug connector housing 22 and/or the tension-protection component 14 may also be formed in multiple parts, so that the adhesive 18 can be introduced when the respective housing halves are not yet assembled.

Also in the exemplary embodiment of FIG. 7, a sealing element 26 is provided by way of example in the plug connector 3. In particular, in the case of a tension-protection component 14 designed as a plug connector housing 22, the optional sealing element 26 may optionally, however, also be formed by the adhesive 18 itself.

1. An arrangement (1) for strain relief of a cable (2), in particular an optical cable (2), comprising: the cable (2) and a tension-protection component (14) fastened to the cable (2) by means of an adhesive (18), characterized in that a cable sheath (8) of the cable (2) within the tension-protection component (14) is removed sectionally circumferentially or completely interrupted peripherally along a cable longitudinal axis (L) such that a cavity (16) is formed between an inner side (15) of the tension-protection component (14) and a cable layer (7) of the cable (2) running below the cable sheath (8), into which cavity the adhesive (18) is introduced.

2. The arrangement (1) according to claim 1, characterized in that said cable layer (7) has reinforcing fibres, in particular aramid fibres, kevlar fibres or a metallic cable shield braiding.

3. The arrangement (1) according to claim 1 characterized in that the cable (2) comprises one or more data lines running below said cable layer (7), in particular one or more optical waveguides (4).

4. The arrangement (1) according to claim 1, characterized in that the tension-protection component (14) is fastened to an end portion (9) of the cable (2), the end portion (9) of the cable (2) being stripped at least sectionally and emerging with an unprocessed rear cable portion (19) from a cable-side opening (20) in the tension-protection component (14).

5. The arrangement (1) according to claim 1, characterized in that in order to form the cavity (16) within the tension-protection component (14), the cable sheath (8) is removed circumferentially at least by an angular range of 30°, preferably at least 45°, more preferably at least 60°, in particular at least 90°.

6. The arrangement (1) according to claim 1, characterized in that in order to form the cavity (16) within the tension-protection component (14), the cable sheath (8) is completely interrupted peripherally at least over an axial length (a) of 1.0 mm, preferably over an axial length (a) of at least 1.2 mm, for example over an axial length (a) of approximately 1.4 mm,

7. The arrangement (1) according to claim 1, characterized in that the adhesive (18) at least substantially completely fills the cavity (16).

8. The arrangement (1) according to claim 1, characterized in that the adhesive (18) is a light-curing, in particular UV-curing, or a thermally curing adhesive (18).

9. The arrangement (1) according to claim 1, characterized in that the adhesive (18) is a self-adhesive, primer-free adhesive (18).

10. The arrangement (1) according to claim 1, characterized in that the tension-protection component (14) has at least one access opening (17) which leads into the cavity (16) and is intended for introducing the adhesive (18),

11. The arrangement (1) according to claim 1, characterized in that the tension-protection component (14) is jointly fastened to a plurality of cables (2), which are arranged in a joint cable receptacle or in respective cable receptacles.

12. The arrangement (1) according to claim 1, characterized in that the tension-protection component (14) is a plug connector housing (22) of a plug connector (3) or a plug connector component which is fastenable in a plug connector housing (22) of a plug connector (3).

13. The arrangement (1) according to claim 1, characterized in that the cable sheath (8) of the cable (2) and/or the inner side (15) of the tension-protection component (14) has at least one recess encircling sectionally circumferentially or completely circumferentially in order to form at least one further cavity (16′, 16″) between the cable sheath (8) of the cable (2) and the inner side (15) of the tension-protection component (14), the further cavity (16′, 16″) being spaced apart from the cavity (16) or extending the cavity (16).

14. A plug connector arrangement (21), comprising:
a plug connector (3), in particular an optical plug connector (3); and
an arrangement (1) for strain relief of a cable (2).

15. A method for mounting a cable (2) in a plug connector (3), comprising at least the following method steps:
providing a cable (2), in particular an optical cable (2);
providing a tension-protection component (14) of the plug connector (3);
removing a cable sheath (8) of the cable (2) sectionally circumferentially, or circumferentially completely severing and carrying out a partial pulling-off of the cable sheath (8), and then introducing the corresponding cable portion into the tension-protection component (14) such that a cavity (16) is formed between an inner side (15) of the tension-protection component (14) and a cable layer (7) of the cable (2) running below the cable sheath (8); and
introducing an adhesive (18) into the cavity (16) in order to fasten the tension-protection component (14) to the cable (2).
